(19) United States
(12) Patent Application Publication
(10) Pub. No.: US 2010/0254708 A1
(43) Pub. Date: Oct. 7, 2010

(54) Laser wavelength stabilization

(76) Inventors: Krzysztof Pradzynski, Santa Clara, CA (US); Oleh Sniezko, Highlands Ranch, CO (US)

Correspondence Address: JOHN BRUCKNER PC, P.O. BOX 17569, SUGAR LAND, TX, 77496-7569, US

(21) Appl. No.: 12/660,936

(22) Filed: Mar. 4, 2010

Related U.S. Application Data
(60) Provisional application No. 61/209,323, filed on Mar. 4, 2009.

(51) Int. Cl. H04J 14/08

(52) U.S. Cl. 398/98

(57) ABSTRACT

A method includes transmitting a plurality of time-division-multiplexed return channels from a plurality of optical network terminal outputs to a plurality of cable modem termination system inputs. Transmitting the plurality of time-division-multiplexed return channels includes transmitting a plurality of frequency-division-multiplexed return signals from the plurality of optical network terminal outputs to the plurality of cable modem termination system inputs. An apparatus includes a plurality of optical network terminals; an optical receiver coupled to the plurality of optical network terminals; an optical splitter coupled to the optical receiver; a plurality of cable modem termination system inputs. A plurality of time-division-multiplexed return channels are transmitted from the plurality of optical network terminals to the plurality of cable modem termination systems and the plurality of time-division-multiplexed return channels include a plurality of frequency-division-multiplexed return signals.

### CROSS-REFERENCE TO RELATED APPLICATION

This application claims a benefit of priority under 35 U.S.C. 119(e) from copending provisional patent application U.S. Ser. No. 61/209,323, filed Mar. 4, 2009, the entire contents of which are hereby expressly incorporated herein by reference for all purposes.

### BACKGROUND INFORMATION

1. Field of the Invention

Embodiments of the invention relate generally to the field of radio frequency over glass networking. More particularly, an embodiment of the invention relates to laser wavelength stabilization in the context of radio frequency over glass networking.

2. Discussion of the Related Art

Telephone companies such as Verizon and AT&T have started to offer services over passive optical networks (PONs) using fiber-to-the-premise (FTTP) and fiber-to-the-curb (FTTC) systems such as FiOS™ and U-verse™. North American cable operators have started deploying their own PON networks. These networks utilize scalable fiber-to-the-home (FTTH) systems, building upon fiber deployed to date, that can offer bandwidths similar to, or higher than, that provided by FiOS™ and U-verse™.

Multiple system operators (MSOs) want to continue utilizing DOCSIS (Data Over Cable Service Interface Specification) platform for wideband services such as high speed data (HSD), Voice over IP (VoIP) and other services supported by this platform, which provides for downstream data bandwidth of 640 Mb/s and beyond, until such a time as yet higher data speeds are required. At such a time, the MSOs want the flexibility to upgrade their FTTH ONT device to handle Gb/s data speeds offered by passive optical networks (PONs) such as GPON (gigabit passive optical network) or gigabit Ethernet passive optical network) GEPON (xPON). They also want to support deployed interactive TV services that are based on set top boxes with active upstream signaling to support fully interactive services such as Video on Demand (VoD) and Switched Digital Video (SDV).

Radio frequency over glass (RFoG) passive optical network (PON) (RFPON) is a name given to a generic FTTH PON architecture that supports legacy DOCSIS cable upstream signals and can be later upgraded to provide additional high speed (>1 Gb/s) PON service(s). FIG. 1 shows a schematic diagram of the RFoG PON system upgraded with additional xPON.

In the RFoG PON architecture, traditional cable services (analog and digital video, VOD, VoIP, HSD, etc.) are transported downstream on wavelength λ_{d1} (typically 1550 nm), while DOCSIS cable upstream signals are on wavelength λᵤ₁ (typically 1590 nm or 1610 nm). None of these wavelengths denote a single wavelength. Rather, they denote a range of wavelengths with the nominal wavelength as listed. For example, 1310 nm wavelength commonly used for upstream signals in GEPN and GPON can encompass wavelengths between 1300 nm and 1320 nm. Additional wavelengths λ_{d1}, λᵤ₂, (and possibly more wavelength pairs) are multiplexed on the same fiber using the wavelength combiner to support high-speed (Gb/s or higher) xPON service(s) such as GEPON, GPON and 10 Gb/s EPON and GPON.

The downstream signal on wavelength λ_{d1} is optically amplified in the headend/hub and broadcast to all the RFoG optical network terminals (ONTs). The upstream data on wavelength λᵤ₁ originates from cable modems attached to the ONTs on a QAM signal at some fixed RF frequency between 0-45 MHz (in North America, other sets of frequencies can be used and are used in Europe, Japan and other countries and regions, any other frequency range can also be used). This upstream QAM signal is extracted by the band-pass filter (BPF) (optional, typically internal to the CMTS) and fed to the cable modem termination system (CMTS) input in the headend/hub.

Although the upstream signals from all ONTs operate in the same wavelength range with the nominal wavelength (λᵤ₁) and at the same RF frequency, and are combined together by the PON splitter/combiner, wavelength collisions are avoided at the upstream optical receiver since GEPON, PON and DOCSIS systems employ time-division multiple access (TDMA). That is, the OLT or CMTS permits only one ONT or cable modem to transmit data at any given time. The ONTs employ burst-mode transmission in the reverse path to ensure that the reverse path laser in the ONT only turns on when it is allowed to transmit (by OLT) or detects incoming data from the cable modem (that is allowed to transmit by CMTS) and is off the rest of the time. In this manner, upstream wavelength collisions are avoided. Avoiding wavelength collisions is of critical importance in a PON system—if two optical signals with the same wavelength are incident on a receiver, optical beating causes a severe degradation of the signal-to-noise ratio (SNR) over the entire return path bandwidth rendering the receiver unable to detect any signals for the duration of the wavelength collision.

### RFoG Limitations

A disadvantage of the RFoG architecture shown in FIG. 1 is the disproportionate cost of transporting the traditional cable return signals—mainly signaling from a set-top-box (STB) and QAM channels for DOCSIS data signals. A major concern is that only one DOCSIS channel (more generally, only one service that is TDMA controlled; e.g., DOCSIS 3.0 can support several bonded reverse channels that are TDMA controlled) is supported in the return band (a QAM channel at a RF frequency between 0-45 MHz in North America). Only in this case, TDMA of the single service allows for wavelength collision avoidance.

### SUMMARY OF THE INVENTION

There is a need for the following embodiments of the invention. Of course, the invention is not limited to these embodiments.

According to an embodiment of the invention, a method comprises: transmitting a plurality of time-division-multiplexed return channels from a plurality of optical network terminal outputs to a plurality of cable modem termination system inputs, wherein transmitting the plurality of time-division-multiplexed return channels includes transmitting a plurality of frequency-division-multiplexed return signals from the plurality of optical network terminal outputs to the plurality of cable modem termination system inputs. According to another embodiment of the invention, an apparatus comprises: a plurality of optical network terminals; an optical receiver coupled to the plurality of optical network terminals; an optical splitter coupled to the optical receiver; a plurality of cable modem termination system inputs, wherein a plurality of time-division-multiplexed return channels are transmitted from the plurality of optical network terminals to the plurality of cable modem termination systems and the plurality of time-division-multiplexed return channels include a plurality of frequency-division-multiplexed return signals.

These, and other, embodiments of the invention will be better appreciated and understood when considered in conjunction with the following description and the accompanying drawings. It should be understood, however, that the following description, while indicating various embodiments of the invention and numerous specific details thereof, is given for the purpose of illustration and does not imply limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer concept of embodiments of the invention, and of components combinable with embodiments of the invention, and operation of systems provided with embodiments of the invention, will be readily apparent by referring to the exemplary, and therefore nonlimiting, embodiments illustrated in the drawings (wherein identical reference numerals (if they occur in more than one view) designate the same elements). Embodiments of the invention may be better understood by reference to one or more of these drawings in combination with the following description presented herein. It should be noted that the features illustrated in the drawings are not necessarily drawn to scale.

FIG. 1 is a view of an RFoG PON architecture where traditional cable services are transported downstream on wavelength λ_{d1} DOCSIS cable upstream signals on wavelength λᵤ₁, upgraded with xPON capabilities where wavelengths λ_{d2}, λᵤ₂, (and possibly more wavelength pairs) are used for Gb/s or higher xPON service(s).

FIG. 2 is a view of an enhanced RFoG PON architecture where multiple DOCSIS cable modem termination systems (CMTSs) utilize the same upstream wavelength range with nominal wavelength λ_{d1}.

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

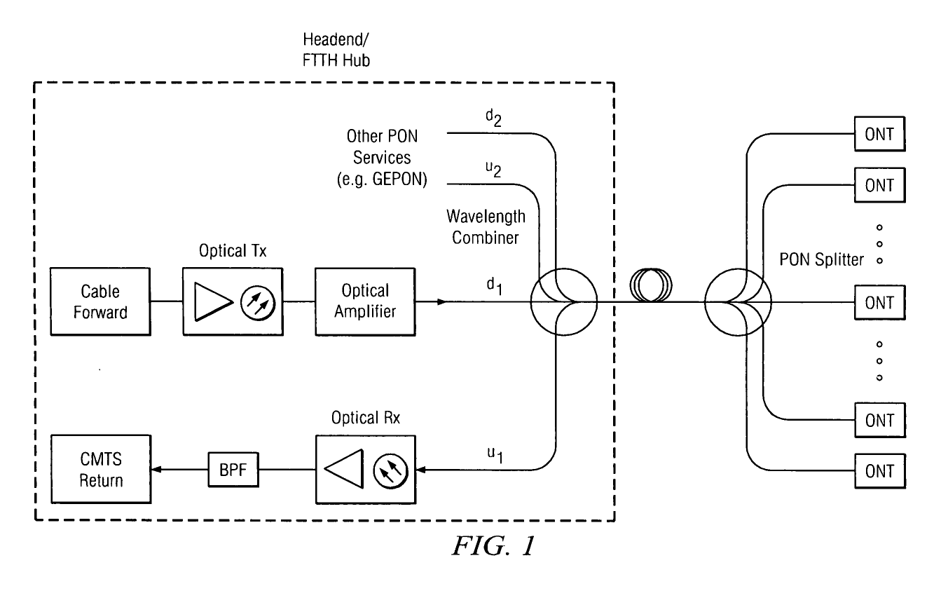

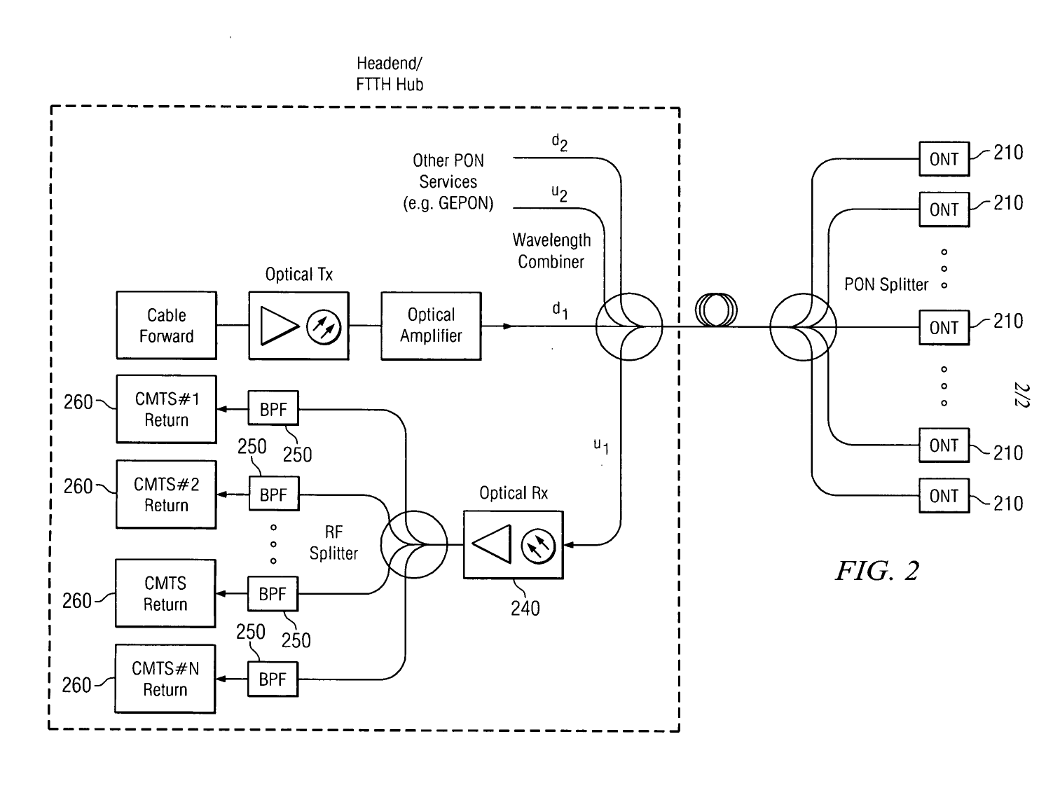

An advantageous, attractive alternative to the RFoG architecture of FIG. 1 is a different version that significantly includes supporting multiple frequency-division-multiplexed (FDM) DOCSIS return channels, as shown in FIG. 2.

This enhanced system utilizes more of the cable return bandwidth to support N DOCSIS channels (with N≧1) (generally, more than one service, DOCSIS channels are just examples of signals supporting one of the services provided in HFC network). The upstream signals of the ONTs 210 (all within the wavelength range with nominal wavelength λᵤ₁) include N QAM channels, optionally each at a different RF frequency within the return band of 0-45 MHz. The output of the return path optical receiver 240 in the headend/hub is split into N band-pass filters 250 (external or internal to CMTS, working at RF or IF, analog or digital), each of which extracts one of the QAM channels and feeds it to the corresponding CMTS 260 at the FTTH node, hub or head-end. In this important way, the N TDMA channels are separated from each other in the return path.

Although the N DOCSIS channels are separated in time and frequency, they share the same group of return lasers in the ONTs that communicate to a single shared receiver. When there is just one DOCSIS channel present (N=1), there is no chance that two lasers are on simultaneously since the TDMA protocol ensures that only one cable modem is transmitting at a time; which means that only one laser is on at any given time due to the use of burst-mode transmission in the ONTs. When there are N DOCSIS channels present (N>1) the possibility arises that as many as N lasers are on simultaneously, each one transmitting data on one of the N DOCSIS channels. The major concern about the viability of the enhanced RFoG architecture of FIG. 2 is that addressing the detection and prevention of wavelength collisions.

More generally, if more than one channel or service is allocated to the service group with ONT communicating to the same receiver, the TDMA control of each service does not necessarily result in TDMA control among all the services; and several ONT transmitters may transmit at the same time. Furthermore, even with a single service or channel support where TDMA is effective under normal operating conditions, after a power outage, many CPE devices (for example, DOCSIS cable modems) attempt to communicate with the service processing equipment at the same time without regard to TDMA. All these situations can lead to wavelength collisions.

Embodiments of the invention can include avoiding collision by keeping all transmitters sufficiently separated (by more than tens of GHz and preferably by hundreds of GHz). This separation is preferably maintained over time and at all operating conditions. Randomly selected lasers for a nominal wavelength (e.g., band) are distributed over a range of (discrete) wavelengths. The laser wavelength selections for the application(s) described above can be based on (decided about) the distribution of these wavelength values. One example of the selection would be to group lasers within wavelength ranges. These wavelength ranges rᵢ would be subsets of the wavelength range R for the entire population of lasers. The separation between the ranges rᵢ can be designed in such a way that lasers from one range cannot change wavelength by the amount that would place them in another range. This can be achieved by designing the separations in such a way that the separation(s) is(are) sufficient enough that thermal changes and laser aging over the operating temperature range and laser expected operating lifespan would not cause wavelength change larger than the change that would result in a collision of wavelengths from two adjacent ranges.

However, such a separation might not be practical for the following reasons: the rate of wavelength change for a DFB laser is on the order of 0.1 nm/degree C. and for a Fabry-Perot laser several times larger. To separate the ranges in such a way that the lasers from two different ranges would not collide (i.e. their wavelengths would not collide), over all the possible ambient temperature ranges that two laser placed in different locations would be subject to, would require the separation between ranges to be larger than several, and possibly more than several, nanometers.

Embodiments of the invention can include limiting the temperature change range by maintaining the laser temperature outside the possible (reasonably foreseeable) ambient temperature range (above the highest expected ambient temperature or below the lowest expected ambient temperature). This is markedly different than the TEC (thermoelectric cooler) approach that is used by industry to maintain laser temperature low (typically around 20 degree C.) and very stable, to maintain very accurate wavelength and, therefore, very good performance that depends on laser parameter stability. Rather, embodiments of the invention can involve either a heater or a cooler that maintains the laser temperature within +/−1 degree C. around a temperature set point that is above or below the (reasonably foreseeable) ambient temperature extremes. Advantageously, this solution is of lower cost and requires lower level of control and lower complexity for laser packaging (laser do not have to be packaged for very good heat dissipation).

Also, maintaining the operating temperature range of the laser within +/−1 degree C. will lower the wavelength change for DFB lasers to below +/−0.1 nm and hence allow for more laser wavelength ranges rᵢ within the wavelength range R for the entire population of lasers due to the fact that the separation between the ranges rᵢ required to avoid laser collision will be lower. The higher number of possible ranges would significantly decrease the probability of the laser collision, if for example four lasers are on out of total of 16 or 32 lasers (the numbers are examples only), even if lasers for a particular RFoG PON group are selected at random.

Additionally, to avoid wavelength collisions during initial registration of CPE devices after a power outage or during initial installation (in this situation, TDMA protocol if often disabled to allow for service restoration and CPE devices often transmit simultaneously), the ONT laser would be turned off or muted until its temperature reaches the fixed level (stored set point or factory set or communicated to the ONT laser remotely).

Embodiments of the wavelength stabilization invention can be used in the context of a self-correcting wavelength collision avoidance system for wavelength collision correction. This can be one of the stages of a self-correcting wavelength collision avoidance system. This can be for re-tuning an optical network terminal laser to a new wavelength and stabilizing the new wavelength after no collision status is achieved and/or in wavelength collision avoidance.

Embodiments of the invention can include placing the lasers within wavelength random ranges.

Embodiments of the invention can include preventing lasers from one range from colliding with lasers from one, some or all other ranges by lowering their wavelength change over their operating ambient temperature ranges and/or their operating life span.

Embodiments of the invention can include lowering the width (spectral width) of the range to allow for more non-colliding ranges within the entire range of wavelengths occupied by entire laser population.

Embodiments of the invention can include lowering laser wavelength change by maintaining their operating temperature range, above or below the extreme ambient temperatures within the desired range, with accuracy required to prevent the collision between lasers from one range with laser from another range (example was given as +/−1 degree C. but it would depend on the separation between the wavelength ranges rᵢ).

Embodiments of the invention can include muting or turning off the ONT laser during its initialization after power outages or maintenance period or after initial installation until it reaches the target, factory set, last memorized or remotely communicated, temperature and wavelength.

### DEFINITIONS

The term program and/or the phrase computer program are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system).

The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term distal, as used herein, is intended to mean far, away, spaced apart from and/or non-coincident, and includes spatial situation where specified functions and/or results (if any) can be carried out and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The phrase any integer derivable therein is intended to mean an integer between the corresponding numbers recited in the specification. The phrase any range derivable therein is intended to mean any range within such corresponding numbers. The term means, when followed by the term “for” is intended to mean hardware, firmware and/or software for achieving a result. The term step, when followed by the term “for” is intended to mean a (sub)method, (sub)process and/or (sub)routine for achieving the recited result. Unless otherwise defined, all technical and scientific terms used herein have the same meaning as commonly understood by one of ordinary skill in the art to which this invention belongs. In case of conflict, the present specification, including definitions, will control.

### CONCLUSION

The described embodiments and examples are illustrative only and not intended to be limiting. Although embodiments of the invention can be implemented separately, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences. The individual components of embodiments of the invention need not be combined in the disclosed configurations, but could be combined in any and all configurations.

Various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising:
transmitting a plurality of time-division-multiplexed return channels from a plurality of optical network terminal outputs to a plurality of cable modem termination system inputs,
wherein transmitting the plurality of time-division-multiplexed return channels includes transmitting a plurality of frequency-division-multiplexed return signals from the plurality of optical network terminal outputs to the plurality of cable modem termination system inputs.

2. The method of claim 1, wherein each of the plurality of frequency-division-multiplexed return signals is transmitted at a different RF frequency within a return band.

3. The method of claim 1, wherein the plurality of time-division-multiplexed return channels include N QAM channels, wherein N is an integer and N≧1.

4. The method of claim 3, wherein the plurality of time-division-multiplexed return channels include N DOCSIS channels.

5. The method of claim 1, further comprising maintaining a temperature of each of a plurality of lasers, each of which is coupled to one of the plurality of optical network terminal outputs, above or below a range of ambient temperatures.

6. The method of claim 5, wherein the temperature is maintained to within approximately +/−1 degree C. of a temperature set point.

7. An apparatus, comprising:
a plurality of optical network terminals;
an optical receiver coupled to the plurality of optical network terminals;
an optical splitter coupled to the optical receiver; and
a plurality of cable modem termination system inputs,
wherein a plurality of time-division-multiplexed return channels are transmitted from the plurality of optical network terminals to the plurality of cable modem termination systems and the plurality of time-division-multiplexed return channels include a plurality of frequency-division-multiplexed return signals.

8. The apparatus of claim 7, further comprising a heat exchanger coupled to a laser of one of the plurality of optical network terminals to maintain the laser above or below a range of ambient temperatures.

9. A hybrid fiber optic network, comprising the apparatus of claim 7.
